(19) United States
(12) Patent Application Publication
(10) Pub. No.: US 2010/0201296 A1
(43) Pub. Date: Aug. 12, 2010

(54) Brushless DC Electric Motor

(76) Inventors: Oleg Anatolievich Buglaev, Saint-Petersburg (RU); Viktor Alexevich Bryzgalov, Saint-Petersburg (RU)

Correspondence Address: PATENT, COPYRIGHT & TRADEMARK LAW GROUP, 4199 Kinross Lakes Parkway, Suite 275, RICHFIELD, OH, 44286, US

(21) Appl. No.: 12/519,994

(22) PCT Filed: Dec. 4, 2008
(86) PCT No.: PCT/RU2008/000742

§ 371 Date: Jun. 18, 2009

(30) Foreign Application Priority Data
Dec. 4, 2007 (RU) 2007145461

(51) Int. Cl. H02P 6/14

(52) U.S. Cl. 318/400.27

(57) ABSTRACT

The invention relates to electrical engineering and can be used, in particular, in electric drives of mechanisms used in dental equipment. A brushless DC electric motor comprises an electromechanical converter (1) with a three-section (2, 3, 4) winding and a permanent-magnet inductor (5), an inverter (6), a control unit (7) and three comparators (1^{st} (8), 2^{nd} (9) and 3^{rd} (10)), wherein the terminals of the winding sections of said electromechanical converter are connected to the 1^{st}, 2^{nd} and 3^{rd} outputs of the inverter (6), respectively, and to the 1^{st} inputs of the 1^{st} (8), 2^{nd} (9) and 3^{rd} (10) comparators, respectively, said motor additionally comprising an electric motor start-up unit (11); and wherein said control unit (7) is a decoder and comprises six optron transmitters (12, 13, 14, 15, 16 and 17) with optical outputs, while the inverter comprises six optron receivers (18, 19, 20, 21, 22 and 23), the optical inputs of said receivers being connected by means of optical coupling to corresponding optical outputs of said optron transmitters (12, 13, 14, 15, 16 and 17) of the control unit (7), and wherein the outputs of the 1^{st} (8), the 2^{nd} (9) and the 3^{rd} (10) comparators are connected to the 1^{st}, 2^{nd} and 3^{rd} inputs of the control unit (7), respectively, while the 7^{th} power input of the inverter (6) is connected to the power source and to the input of the electric motor start-up unit (11), the 1^{st} output of said start-up unit (11) being connected to the 3^{rd} input of the 2^{nd} (9) comparator, its 2^{nd} output being connected to the 3^{rd} input of the 3^{rd} (10) comparator, and wherein the 2^{nd} inputs of all comparators are interconnected with each other. The present invention provides an increase of operational reliability and stability of the brushless DC electric motor, as well as reduction of the torque pulsations.

### TECHNICAL FIELD

The invention relates to electrical engineering and can be used, in particular, in electric drives of mechanisms used in dental equipment.

### BACKGROUND ART

A known controlled brushless DC electric motor comprises an electromechanical converter with a permanent-magnet inductor, the 1^{st} terminals of the three sections of the armature winding of said inductor being joined together and connected to the common bus of the brushless DC electric motor, a full-wave frequency converter, the outputs of said converter being connected to the 2^{nd} terminals of the armature winding sections, a logical control unit, the outputs of said control unit being connected to the control inputs of the full-wave frequency converter, and three comparators, each having two inputs, the outputs of said comparators being respectively connected to the inputs of the logical control unit. The brushless DC electric motor also comprises three integrating circuits. The 1^{st} input of the i-th comparator is connected to the 2^{nd} terminal of the i-th section of armature winding, while the output of said comparator is connected to the input of the (i−1)th integrating circuit. The output of the (i−1)th integrating circuit is connected to the 2^{nd} input of the i-th comparator, wherein the abovementioned connection between the comparators and the integrating circuits forms a ring coupling, SU 1774455 A1.

The disadvantage of said brushless DC electric motor consists in that there is a shift at the outputs of the integrating circuits relative to the common terminal when the motor operates in the mode of rotation frequency stabilization, which results in different switching thresholds of the rotational-EMF comparators and, consequently, in different lead angles at which the sections are powered during positive and negative intervals of the rotational EMF. Nonsymmetric voltage shapes at the armature winding sections result in additional torque pulsations, increased detonation and, consequently, deterioration of operating qualities of the brushless DC electric motor.

The brushless DC electric motor according to RU 2091978 C1 improves the operating qualities of the motor, in particular, it increases its service life by reducing the torque pulsations.

This electric motor comprises an electromechanical converter with a winding, which consists of three sections, and a permanent magnet inductor. The terminals of the winding sections are joined together and connected to the common bus. The device also comprises a voltage inverter, a control unit based on the “OR” and “AND” logical elements, and three comparators; start-up of the electric motor is done by means of integrating circuits; the inverter is a three-phase bridge based on transistors. Terminals of the electromechanical converter windings are connected to corresponding outputs of the inverter and to the inputs of the 1^{st}, 2^{nd} and 3^{rd} comparators, respectively, and the electric motor is connected to a bipolar power source, RU 2091978 C1.

This engineering solution has been taken as a prototype of the present invention.

The control unit of the prototype device is based on logical elements, which are electrically connected with the inverter elements. Said logical elements have a relatively small range of acceptable fluctuations of the voltage that is supplied to the power input of the inverter. If this range is exceeded, for example, because of a defect in the power supply device, the voltage suppressors or the inverter itself, then the logical unit will break down.

It should also be mentioned that high power currents of the electromechanical converter winding have a negative effect on the control unit through the inverter, which leads to unstable operation of the electric motor (emergency operation mode).

The abovementioned disadvantages become even more pronounced upon increase of required capacity of the brushless DC electric motor, which narrows the list of possible applications of the prototype device, limiting it to low-load electric drives, for example, drives of magnetic tape-driving mechanisms of tape recorders.

Another serious disadvantage of the prototype consists in the fact that special integrating circuits are used for starting the electric motor. The inevitable dispersion of parameters of said circuits produces a certain shift at their outputs relative to the common terminal in the mode of rotation frequency stabilization, which creates additional torque pulsations of the electric motor. The prototype device does not provide a satisfactory solution for reducing said pulsations (due to the abovementioned dispersion of parameters of the integrating circuits), although pulsations in RU 2091978 C1 are somewhat smaller than in SU 1774455 A1.

### SUMMARY OF THE INVENTION

It is an object of this invention to provide a solution for increasing the stability and reliability of operation of the brushless DC electric motor, and for reducing the torque pulsations of the electric motor.

According to the invention there is provided a brushless DC electric motor, which is connected to a power source and comprises an electromechanical converter with a three-section winding and a permanent-magnet inductor, an inverter, a control unit and three comparators (1^{st}, 2^{nd} and 3^{rd}), wherein the terminals of the winding sections of said electromechanical converter are connected to the 1^{st}, 2^{nd} and 3^{rd} outputs of the inverter, respectively, and to the 1^{st} inputs of the 1^{st}, 2^{nd} and 3^{rd} comparators, respectively, said motor additionally comprising an electric motor start-up unit; and wherein said control unit comprises six optron transmitters with optical outputs, while the inverter comprises six optron receivers, the optical inputs of said receivers being connected by means of optical coupling to corresponding optical outputs of said optron transmitters of the control unit, and wherein the outputs of the 1^{st}, 2^{nd} and 3^{rd} comparators are connected to the 1^{st}, 2^{nd} and 3^{rd} inputs of the control unit, respectively, while the 7^{th} power input of the inverter is connected to the power source and to the input of the electric motor start-up unit, the 1^{st} output of said start-up unit being connected to the 3^{rd} input of the 2^{nd} comparator, its 2^{nd} output being connected to the 3^{rd} input of the 3^{rd} comparator, and wherein the 2^{nd} inputs of all comparators are interconnected with each other.

The applicant hasn't found any sources of information containing data on engineering solutions identical to the present invention. In applicant's opinion, this enables to conclude that the invention conforms to the criterion “Novelty” (N).

The novel features of the present invention provide the device with new properties, which are very important for the practical application of said device. Electric connection between the inverter and the control unit is prevented due to the fact that the control unit comprises option transmitters, and the inverter comprises optron receivers, the optical inputs of said receivers being optically coupled to the outputs of said option transmitters thus forming an optron pair with said option transmitters. Therefore, fluctuations of the supply voltage, defects of the power source or the inverter itself cannot damage the control unit; furthermore, high power currents of the electromechanical converter winding cannot influence the control unit through the inverter, which significantly increases stability of the electric motor operation and virtually prevents the occurrence of emergency operating mode; therefore, it becomes possible to significantly increase the capacity of the electric motor, in particular, towards values required for application of the motor in electric drives of dental equipment mechanisms.

Finally, the existence of the electric motor start-up unit makes it possible to exclude from the process the integrating circuits, which inevitably possess different inherent parameters and cause additional torque pulsations in the prototype; reduction of said pulsations significantly improves the operational qualities of the electric motor.

In applicant's opinion, the abovementioned facts enable to conclude that the present invention conforms to the criterion “Inventive Step” (IS).

### BRIEF DESCRIPTION OF THE DRAWINGS

The invention is further explained, by way of example, with reference to the following drawings, in which:

FIG. 1 is a diagram of the device;

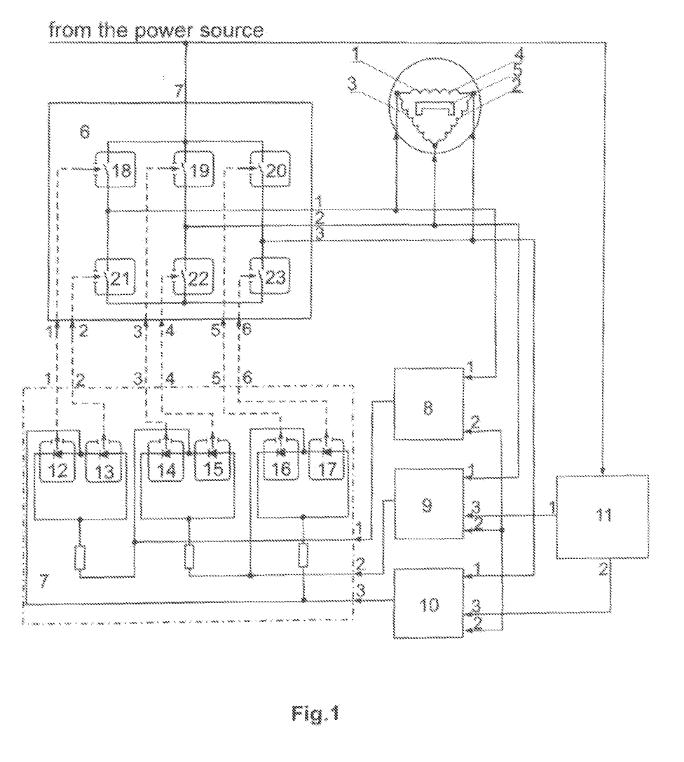

FIG. 2 is a schematic diagram of the electric motor start-up unit.

### DETAILED DESCRIPTION OF THE ILLUSTRATED EMBODIMENT

The brushless DC electric motor is connected to a power source, in particular, to a controlled switching regulator (not shown in the figure), and comprises an electromechanical converter 1 with a three-section winding (sections 2, 3 and 4), in this particular embodiment the sections are interconnected in a triangle-like circuit; however, they can also be interconnected in a star-like circuit. Inductor 5 is based on permanent magnets. The inventive device also comprises an inverter 6, a control unit 7, 1^{st} comparator 8, 2^{nd} comparator 9 and 3^{rd} comparator 10; the terminals of sections of the electromechanical converter winding are connected to the 1^{st}, 2^{nd} and 3^{rd} outputs of the inverter 6, respectively, as well as with the 1^{st} inputs of the 1^{st} comparator 8, 2^{nd} comparator 9 and 3^{rd} comparator 10, respectively; the inventive device also comprises an electric motor start-up unit 11. Said control unit 7 comprises six optron transmitters 12, 13, 14, 15, 16 and 17 with optical outputs, while the inverter 6 comprises optron receivers 18, 19, 20, 21, 22 and 23 with switches, the optical inputs of said optron receivers being optically coupled with corresponding optical outputs of said optron transmitters 12, 13, 14, 15, 16 and 17 of the control unit 7. Said optron transmitters and optron receivers form optron pairs (optrons) interconnected with each other by means of optical coupling. This particular embodiment uses optrons produced by COSMO company (K1010D) and field transistors IRL024N, which act as controlled switches of the inverter 6. The electric motor start-up unit 11 consists of an operational amplifier 24 (microcircuit LM324N), a bipolar transistor 25 (BC327-40), diodes 26 and 27 (IN4148), and a ceramic capacitor 28 (MDR104ZA, 0.1 mF 100V Y5V). The operational amplifier 24 and diode 26 form a Schmitt trigger with a given hysteresis curve, with trigger voltage of 1 V and dropout voltage of 0.1 V. The outputs of the 1^{st} comparator 8, 2^{nd} comparator 9 and 3^{rd} comparator 10 are connected to the 1^{st}, 2^{nd} and 3^{rd} inputs of the control unit 7, respectively, while the 7^{th} power input of the inverter 6 is connected to the power source and to the input of the electric motor start-up unit 11, the 1^{st} output of said start-up unit 11 being connected to the 3^{rd} input of the 2^{nd} comparator 9 and its 2^{nd} output being connected to the 3^{rd} input of the 3^{rd} comparator 10, and wherein the 2^{nd} inputs of all comparators are interconnected.

The device operates in the following way. When the brushless DC electric motor is turned off, voltage from the power source equals 0. This means that zero voltage is supplied to the input of the start-up unit 11 (the inverting input of the Schmitt trigger) from the power source; voltage from the output of the Schmitt trigger is supplied in the form of a ‘logical high’ through diode 27 and then through the 1^{st} output of the start-up unit 11 to the 2^{nd} input of the 2^{nd} comparator 9; forced initial logical combination of 1.0.1 is generated at the three (1.2.3) inputs of the control unit 7, said optron transmitters 17 and 14 and corresponding optron receivers 19 and 23 being activated at this time; section 2 of the electromechanical converter winding is connected to the power source through the switches of the optron receivers 19 and 23. When the electric motor is turned on, the voltage of the power source begins to grow from zero to the specified value. When the voltage value is below the specified triggering threshold of the start-up unit 11, i.e. below 1 V, then the value of current (1 inv) consumed by the inverter 6 from the power source can be calculated by the following formula:

1 inv=3E inv/2Rsect (for sections 2, 3 and 4 interconnected in a triangle-like circuit) 1)

1 inv=E inv/2Rsect (for sections 2, 3 and 4 interconnected in a stair-life circuit), 2)

where:

E inv is the supply voltage of the inverter,

Rsect is the resistance of one section of the electric motor winding.

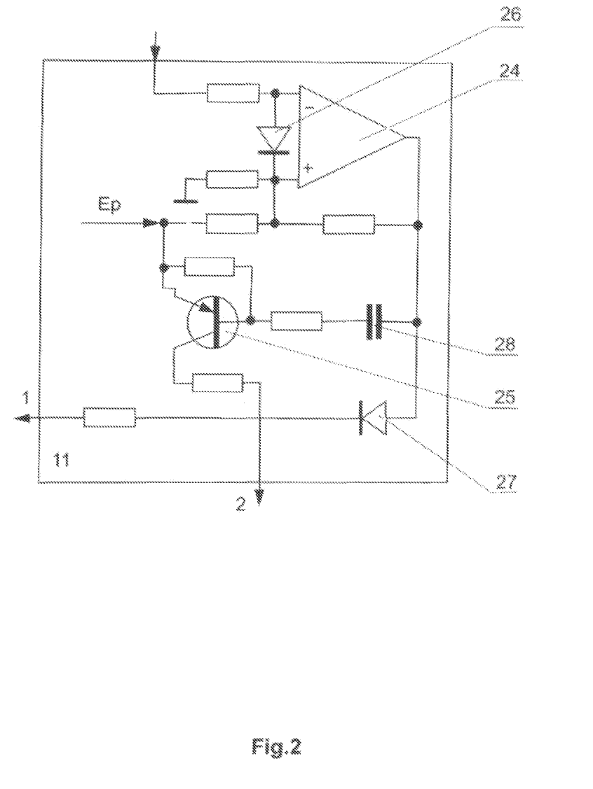

At the initial point of the electric motor start-up, when the growing voltage of the power supply source has not reached the triggering threshold of the unit 11 yet, the inductor 5 sets into a rigidly defined angular position due to the influence of the increasing magnetic field of windings 2, 3 and 4. When the supply voltage of the inverter 6 reaches the triggering voltage value of the unit 11, its 1^{st} output becomes disconnected from the comparator 9 because of the locked diode 27, and a starting pulse is formed at its 2^{nd} output by means of the bipolar transistor 25 and capacitor 28 (FIG. 2); at this moment the electric motor is started and then, when the starting pulse is over, the unit 11 becomes disconnected from the comparator 10 because of the locked transistor 25; the electric motor enters the self-synchronization mode due to the back EMF, which is induced in the electric motor windings upon rotation of the inductor 5 and is detected from its three-phase winding by means of the three comparators 8, 9 and 10. When the inputs 1.2.3. of the unit 7 transmit the forced initial logical combination of 1.0.1. and the growing voltage of the power supply source has not reached the triggering threshold of the unit 11 yet, the back EMF, which is induced in the electric motor windings due to the rotation of the inductor 5, is not accepted by the comparators 8, 9 and 10. After the starting pulse the forced initial logical combination of 1.0.1 at the three inputs 1.2.3 of the unit 7 is replaced with the forced starting logical combination 1.0.0; option transmitters (OT) 14 and 13, as well as corresponding optron receivers (OR) 19 and 21, become activated; also the section 3 of the electromechanical converter winding becomes connected to the power supply source instead of section 2 and, as a result, the magnetic field vector turns by 60 degrees, and the inductor 5 accelerates to occupy a new angular position; because of this, back EMF is induced at the windings of the electric motor. When the starting pulse is over, the comparators 8, 9 and 10 begin to accept the back EMF, whereupon the electric motor switches to the self-synchronization mode. Now the electric motor can be controlled: the torque at its shaft is proportional to the value of current in its windings, while the rotation speed of the inductor 5 is proportional to the value of voltage of the power supply source. The optron transmitters 12, 13, 14, 15, 16 and 17 are electrically interconnected in such a way that they provide an optical isolation for the inverter 6 and also act as an optron decoder, which uses the inverter 6 to implement the algorithm of 120-degree commutation of voltages of the three-phase load—the windings of the electromechanical converter 1. In this 120-degree commutation only two phases are connected to the power supply source at any given moment, while the 3^{rd} phase is used to measure the back EMF. In the self-synchronization mode, the comparators 8, 9 and 10 successively generate 6 code sequences at the three inputs 1.2.3 of the control unit 7 per one rotation of the inductor 5:
1) (1.0.1)—the OT(17.14) and OR(23.19) are activated, section 2 becomes ON
2) (1.0.0)—the OT(14.13) and OR(19.21) are activated, section 3 becomes ON
3) (1.1.0)—the OT(13.16) and OR(21.20) are activated, section 4

becomes ON
4) (0.1.0)—the OT(16.15) and OR(20.22) are activated, section 2 becomes ON
5) (0.1.1)—the OT(15.12) and OR(22.18) are activated, section 3 becomes ON
6) (0.0.1)—the OT(12.17) and OR(18.23) are activated, section 4 becomes ON.

The 1^{st} and 2^{nd} code combinations are used for starting the electric motor. In general, any two adjacent code combinations can be used for starting the electric motor. The 3^{rd}, 4^{th}, 5^{th} and 6^{th} code combinations are used for automatic generation of three-phase voltage at the electric motor windings during its operation under self-synchronization conditions.

### INDUSTRIAL APPLICABILITY

The present invention uses simple means to significantly increase the reliability and stability of operation of the brushless DC electric motor, and reduce the torque pulsations.

In applicant's opinion, this enables to conclude that the invention conforms to the criterion “Industrial Applicability” (IA).

1. A brushless AC electric motor that is connected to a power source and comprises an electromechanical converter with a three-section winding and a permanent-magnet inductor, an inverter, a control unit and three comparators (1^{st}, 2^{nd} and 3^{rd}), wherein the terminals of the winding sections of said electromechanical converter are connected to the 1^{st}, 2^{nd} and 3^{rd} outputs of the inverter, respectively, and to the 1^{st} inputs of the 1^{st}, 2^{nd} and 3^{rd} comparators, respectively, characterized in that said motor additionally comprises an electric motor start-up unit, wherein said control unit comprises six optron transmitters with optical outputs, while the inverter comprises six optron receivers, the optical inputs of said receivers being connected by means of optical coupling to corresponding optical outputs of said optron transmitters of the control unit, and wherein the outputs of the 1^{st}, 2^{nd} and 3^{rd} comparators are connected to the 1^{st}, 2^{nd} and 3^{rd} inputs of the control unit, respectively, while the 7^{th} power input of the inverter is connected to the power supply source and to the input of the electric motor start-up unit, the 1^{st} output of said start-up unit being connected to the 3^{rd} input of the 2^{nd} comparator, its 2^{nd} output being connected to the 3^{rd} input of the 3^{rd} comparator, and wherein the 2^{nd} inputs of all comparators are interconnected with each other.

2. In a brushless AC electric motor having a power source forming an electromechanical converter hand having a three-section winding and a permanent-magnet inductor, an inverter, a control unit and three comparators (1^{st}, 2^{nd} and 3^{rd} ), wherein the terminals of the winding sections of said electromechanical converter are connected to the 1^{st}, 2^{nd} and 3^{rd} outputs of the inverter, respectively, and to the inputs of the 1^{st}, 2^{nd} and 3^{rd} comparators, respectively, wherein the improvement comprises:
an electric motor start-up unit;
said control unit comprising six optron transmitters with optical outputs;
said inverter comprising six optron receivers, wherein optical inputs of said receivers are operatively optically coupled to corresponding optical outputs of said option transmitters of said control unit;
wherein the outputs of the 1^{st}, 2^{nd} and 3^{rd} comparators are operatively connected to the 1^{st}, 2^{nd} and 3^{rd} inputs of the control unit, respectively, and
wherein a 7^{th} power input of said inverter is connected to said power supply source and to the input of said electric motor start-up unit, and
wherein said 1^{st} output of said start-up unit is operatively connected to the 3^{rd} input of the 2^{nd} comparator, and
wherein said 2^{nd} output is operatively connected to the 3^{rd} input of the 3^{rd} comparator, and
wherein the 2^{nd} inputs of all comparators are interconnected with each other.

3. The brushless AC electric motor of claim 2, wherein electric connection between the inverter and the control unit is prevented.

4. The brushless AC electric motor of claim 2, wherein said electric motor start-up unit prevents additional torque pulsations from the operational qualities of the electric motor.
